(19) United States
(12) Patent Application Publication
(10) Pub. No.: US 2008/0151912 A1
(43) Pub. Date: Jun. 26, 2008

(54) METHOD AND APPARATUS FOR PROVIDING A SECURE TRANSMISSION OF PACKET DATA FOR A USER EQUIPMENT

(75) Inventors: Donald Joong, Montreal (CA); Kenneth Ormsby, Newmarket (CA); Samy Touati, Rosemere (CA); Hung Tran, Town Mount Royal (CA); Alain Konstantinov, Laval (CA)

Correspondence Address: ERICSSON CANADA INC.;PATENT DEPARTMENT, 8400 DECARIE BLVD., TOWN MOUNT ROYAL, QC, H4P 2N2, omitted

(73) Assignee: TELEFONAKTIEBOLAGET LM ERICSSON (PUBL), Stockholm (SE)

(21) Appl. No.: 11/615,403

(22) Filed: Dec. 22, 2006

(51) Int. Cl. H04Q 7/00; H04L 12/56

(52) U.S. Cl. 370/401; 370/473

(57) ABSTRACT

A method for providing a secure transmission of packet data on a plurality of network access modes in a packet data network. The UE-1 comprises a processing module for initiating communication with one or more receiving UE-2, operating a spread spectrum access (SS) middleware for communicating to a service application (SA) server for retrieving available access modes of the one or more receiving UE-2. The processing module retrieves available access modes for the one or more receiving UE-2, randomly breaks up an uplink transmission of packet data on multiple transmissions of packet data on available access modes of the UE-1 and sends packet data of the transmissions on available access modes of the UE-1.

### TECHNICAL FIELD

The invention relates to a method and apparatus for providing a secure transmission of packet data between user equipments (UEs).

### BACKGROUND

Wireless broadband access is becoming more readily available. With 3G networks' deployments, WiFi hotspots and Worldwide Interoperability for Microwave Access (WiMAX) as defined by the WiMAX forum www.wimaxforum.org in June 2001. Therefore, a user of a user equipment (UE) may have multiple broadband networks to choose from and to subscribe simultaneously. Also, with Voice over Internet Protocol (VoIP) technology, voice communication can now also occur over IP broadband networks.

Since law enforcement agencies are provided with tools that can intercept and decrypt communication between communicating parties, an encryption protocol can easily be hacked and decrypted. Thus, it is becoming feasible for a fraudulent party to take advantage of this situation.

Thus, a secure communication or transmission of packet data is becoming of great importance for users of wireless equipments. Communicating parties may request to be certain that no one is able to listen or intercept their voice or data communication. However, dedicated physical lines or dedicated circuits are expensive and impossible to deploy in a mass ubiquitous network.

For these reasons, there is a need to provide a secure communications between sending and receiving UEs in a packet data network. The invention provides a solution to that problem.

### SUMMARY

It is a broad aspect of the present invention to provide a method for providing a secure transmission of packet data on a plurality of network access modes in a packet data network, the method comprising the steps of:

initiating communication from a sending user equipment (UE-1) with one or more receiving UE-2;

retrieving available access modes for the one or more receiving UE-2;

randomly breaking up an uplink transmission of packet data on multiple transmissions of packet data on available access modes of the sending UE-1; and

sending packet data of the transmissions on available access modes of the sending UE-1.

It is another broad aspect of the present invention to provide a user equipment (UE-1) for communicating in a packet data network, the UE-1 comprising:

a processing module for initiating communication with one or more receiving UE-2, operating a spread spectrum access (SS) middleware for retrieving available access modes of the one or more receiving UE-2; and

wherein the processing module retrieves available access modes for the one or more receiving UE, randomly breaks up an uplink transmission of packet data on multiple transmissions of packet data on available access modes of the UE-1 and sends packet data of the transmissions on available access modes of the UE-1.

### BRIEF DESCRIPTION OF THE DRAWINGS

The foregoing and other aspects, features, and advantages of the invention will be apparent from the following more particular detailed description as illustrated in the accompanying drawings in which reference characters refer to the same parts throughout the various views. The drawings are not necessarily to scale, emphasis instead being placed upon illustrating the principles of the invention.

FIG. 1 is a schematic diagram illustrating a packet data network for providing a secure transmission from a user equipment (UE) in accordance to the invention;

FIG. 2 is a user data repository for storing UE information of UEs registered at a SA in accordance to the invention;

FIG. 3 is a method for providing a secure transmission of packet data from and to a sending UE-1 and one or more receiving UE-2.

### DETAILED DESCRIPTION

In the following description, for purposes of explanation and not limitation, specific details are set forth such as particular architectures, interfaces, techniques. In order to provide a thorough understanding of the present invention. However, it will be apparent to those skilled in the art that the present invention may be practiced in other embodiments that depart from these specific details. In other instances, detailed descriptions of well known devices, circuits, and methods are omitted so as not to obscure the description of the present invention with unnecessary detail.

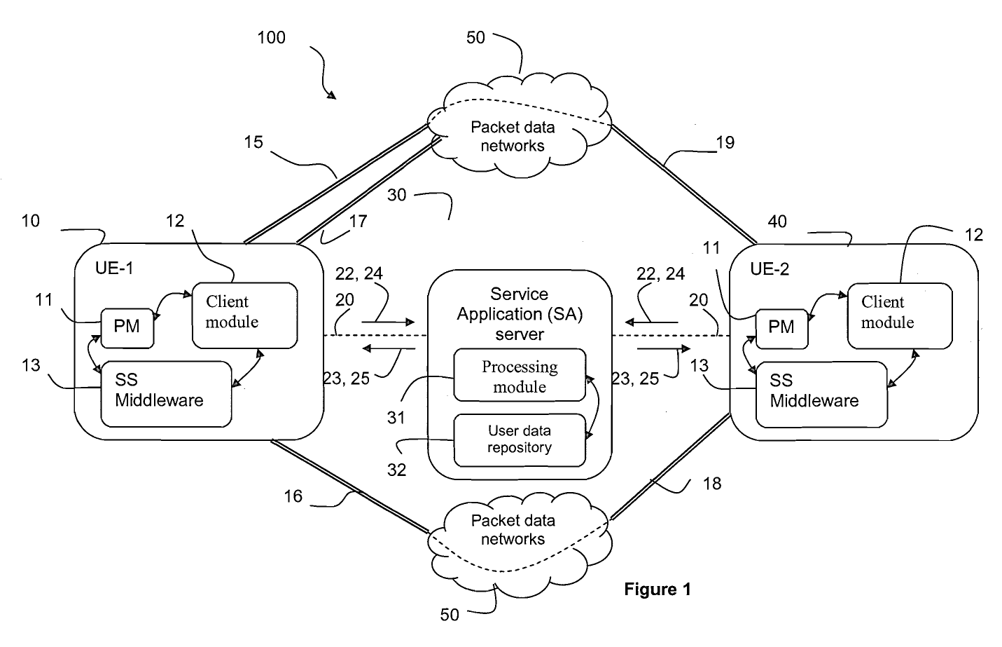

Reference is now made to FIG. 1, which is a schematic diagram illustrating a packet data network 100 for providing a secure transmission of packet data between user equipments (UEs) associated to a service application (SA) server 30 in accordance to the invention. The network 100 includes many network access interfaces or access modes like, but not limited to, a WiMAX network, an Evolution-Data Optimized (EVDO) network, Wireless Local Area Network (WLAN) using an 802.11x protocol defined and published by the Institute of Electrical and Electronics Engineers (IEEE), a 3G Global System for Mobile communications (3GSM) or more generally a Universal Mobile telecommunication System (UMTS) network defined and published by the Third Generation Partnership Project (3GPP), an optical, a broadband network or any combination thereof. Thus, the packet data network 100 may be any network that can provide packet data services to a UE.

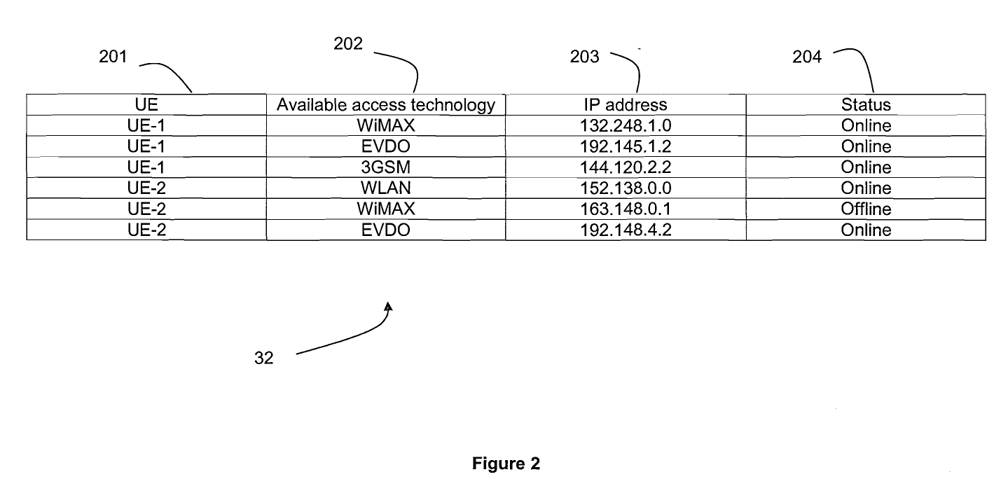

The SA 30 comprises processing module 31 for receiving/sending information message from/to UEs (e.g. UE-1 10 or UE-2 40) and network elements interconnected in the network 100. The communication between the SA 30 and the UE in the network 100 are transmitted on the signaling connection 20. The communication messages 22 to 25 can be sent using known technologies such as Short Message Service (SMS), IP Multimedia Subsystem (IMS), Multimedia Messaging Service (MMS) as defined and published by the third generation (3G) partnership project (3GPP) and 3G partnership project 2 (3GPP2) or any technology that can provides a real-time exchange between a UE and the SA 30. The processing module 31 operates the SA 30 and generates messages that are sent from the server 30. The SA also comprises a user data repository 32 for storing information that can be accessed by the processing module 31. Reference is now made to FIG. 2A, which is a user data repository 32 of UEs registered at the SA 30. The SA 30 can be, but not being limited to, a server or a web based application. The session data 33 and the user data repository 32 can be any persistent memory like a Read-Only Memory (ROM), a Structured Query Language (SQL) database or a Flash memory.

The repository 32 stores UE information for each UE in accordance to the invention, gives an example of what may be the content of the repository. The user data repository 32 may include IDs 201 such as, while not being limited to, an International Mobile Subscriber Identity (IMSI), a username or a Network Access Identifier (NAI) of the UE 10 and that can be a common identity used by the SA 30, available network access 202, an IP address for each network access 203 and the status 204 of the UE on each network access 203. More particularly, the repository 32 is a sort of routing table for storing the different network access modes used from the Spread Spectrum access (SS) middleware 13 of a sending UE for randomly breaking up the transmission of packet data into multiple transmissions and used from the SS middleware 13 of a receiving UE for receiving the multiple transmissions of packet data on multiple network access modes.

The network 100 is a simplified network and the cells and access points (APs) e.g. base stations (BSs), which provide packet data radio access to a UE, are not represented in FIG. 1. The UE can be any mobile equipment that is adapted to receive packet data services such as Voice over Internet Protocol (VoIP). The UE comprises processing module (PM) 11 for receiving and sending information from/to an AP or other network elements in the network 100. The PM 11 operates the UE and processes the received information and generates messages to be sent to other network elements in network 100 or other UEs. The UE also comprises a multi-access client module 12 such as a Subscriber Identity Module (SIM) client that contains authenticating information for allowing the UE to access a plurality of wireless broadband access networks simultaneously. This information is accessible by the PM 11 and a SS middleware 13. The SS middleware 13 operates between a UE's communication application and the Transmission Control Protocol (TCP)/User Datagram Protocol (UDP) Internet Protocol (IP) stack (TCP/UDP) IP stack. The TCP/UDP IP stack description can be found at the Internet Engineering Task Force (IETF) w3.ietf.org The Multiple access interfaces or modes of the client module 12 drivers reside beneath the IP stack. The SS middleware 13 can be, while not being limited to, a software application to be operated by the PM 11 and that can buffer packet data of transmissions received at a UE the SS middleware can also be a combination of the description above and a computer readable medium to be operated by the PM 11.

The UE can be wirelessly connected or physically connected to one of the network elements that provide network access to one of the multiple types of networks in the network 100. The processing modules 11 and 31 can be hardware, software, or any combination thereof. In particular, the UE refers to a device that is operable on, while not being limited to, the different access modes (3GSM, WiMAX, WLAN, UMTS, etc.) described above for the network 100.

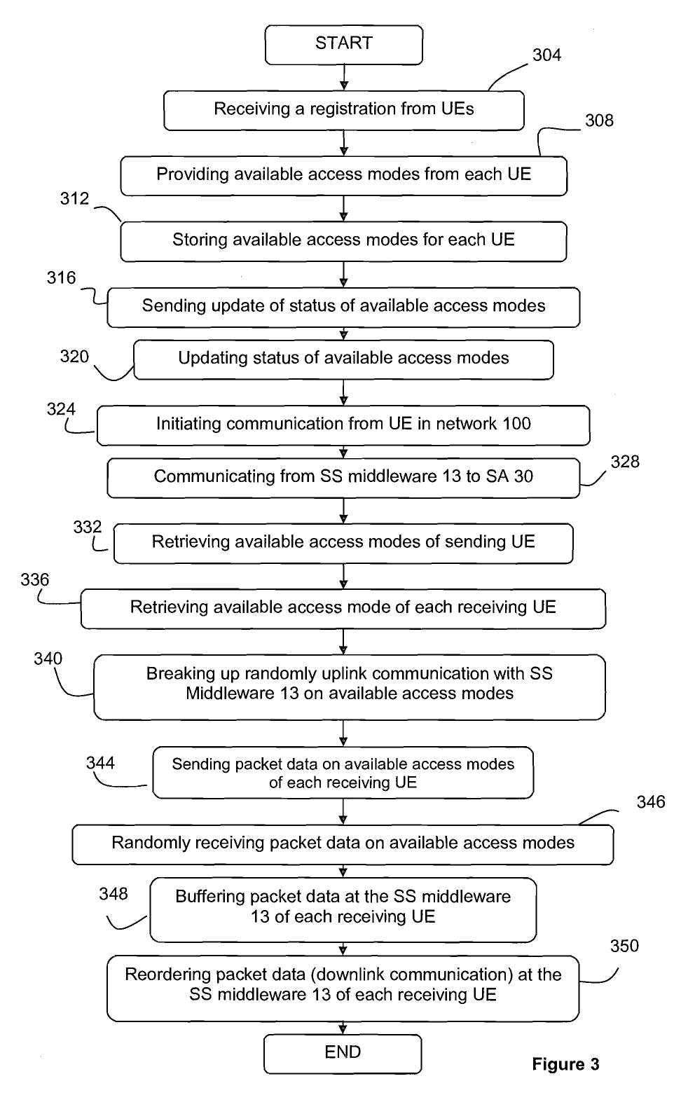

The SS middleware 13 is ultimately connected to the SA 30 for providing a secure transmission of packet data from a sending UE to a receiving UE. Reference is now made to FIG. 3, which describes a method for providing a secure transmission of packet data between a sending UE-1 10 and one or more receiving UE-2. The SA 30 first received registration messages 22 from UEs that request the service for secure a transmission of packet data (step 304). The SA 30 then reply to each requesting UEs with a message 23 for requesting their available access network modes.

Thus, UE-1 10 and UE-2 40 is the given example of FIG. 3 reply with a message 24 to the SA 30 (step 308). The available access network modes 202 for the sending UE-1 10 and the receiving UE-2 40 are stored for further use (step 312). When any of this information changes, an update is also sent back to the SA 30. In particular, a control message 25 is also sent from an updating UE to the other UE informing it to make a query the central server, if a change occurs during a communication session. Thus, the message 24 can also be a trigger at the SA 30 an update consisting of a status update 204 (step 316). In such case the SA 30 updates the user data repository 32 (step 320). When a communication is initiated from the sending UE-1 10 in network 100, the SS middleware 13 sends a message 22 (step 328) to the SA 30 for querying the SA 30 to determine the available interfaces available of UE-2 40 (step 336). Simultaneously, the SA 30 retrieves the available interfaces of the sending UE-1 10 (step 332). At step 340, the sending SS middleware of the sending UE-1 randomly break up its uplink packet communication across its available interfaces towards the receiving UE-2 40. The packet data are then sent on the available network access 202 of the sending UE-1 10 (step 344). The packet data are sent towards networks 50 such as the Internet. For example, the available interfaces 202 of the sending UE-1 can be WiMax (connection 15), EVDO (connection 16), and 3GSM (connection 17).

Within the packet stream of each available network access 202 of the sending UE-1 10 party A, the packet data's destination address for the receiving UE-2 40 are also randomized to take on an IP address 203 associated with one of the available interfaces of the receiving UE-2 40. For example, the available interfaces 202 of the receiving UE-2 can be WLAN (connection 18), EVDO (connection 19). FIG. 2A shows that the receiving UE-2 has a WiMAX network access mode, but this access 202 is not used since it is offline.

The SS middleware 13 on the receiving UE-2 40 is be responsible for buffering packets on all its available interfaces and then reordering it appropriately before feeding it to the appropriate applications. More particularly, the packet data are then sent on the available network access mode (step 346) and then buffered at the SS middleware 13 of the receiving UE-2 40 (step 348). Following this, the SS middleware 13 of the receiving UE-2 40 reorders the packet data in order to obtain the transmission of packet data originally sent from the UE-1 before the sending UE-1 randomly breaks up an uplink transmission of packet data on multiple transmissions (step 350). The receiving UE-2 40 performs the same steps (324 to 344) for its uplink communication with the UE-1 10. The method is described having regard on an example of transmission from the UE-1 being the sending UE-1 10 and UE-2 40 being the receiving UE. Thus, it can be understood that both the UE-1 10 and the UE-2 40 can receive and send packet data at any time during the execution of the steps (304 to 350) of the method. Furthermore, it can also be appreciated that the UE-1 10 or UE-2 40 can be involved in a teleconference call or a videoconference call with multiple other UEs (not shown) and that the packet data can also be transmitted in a secure manner. Some of the steps (304 to 350) can be performed simultaneously or in a continuous manner to steps 304 to 350. The SS middleware 13 can also be used for load balancing purposes between the different network access modes 202. Furthermore, The UE-1 10 and UE-2 40 are considered authenticated on the respective network access modes 202 before initiating a communication or that they may be authenticated at a later time during the transmission of packet data. In this case an update is sent to the SA from the appropriate SS middleware 13.

It can be understood that the present invention is not limited to VoIP services, Gaming or Internet Protocol Television (IPTV), and it should be clear that any real-time transmissions and non real-time transmissions of packet data (File Transfer Protocol (FTP), e-mail packet data service) to be secured and balanced that can be provided by the present network 100 is also encompassed.

In general, some messages and therefore some parameters sent between network elements of the packet data network 100 are omitted for clarity reasons. More particularly, it should also be understood that FIG. 1 depict a simplified packet data network 100, and that many other network elements have been omitted for clarity reasons only. Hence, the packet data network 100 may comprise more than the number of network elements present in FIG. 1. In the same line of thoughts, the packet data network 100 can be accessed by more than one UE and that a plurality of UEs can access simultaneously the packet data network 100.

While the invention has been particularly shown and described with reference to the preferred embodiments thereof, it will be understood by those skilled in the art that various alterations may be made therein without departing from the spirit and scope of the invention.

What is claimed is:

1. A method for providing a secure transmission of packet data on a plurality of network access modes in a packet data network, the method comprising the steps of:
initiating communication from a sending user equipment (UE-1) with one or more receiving UE-2;
retrieving available access modes for the one or more receiving UE-2;
randomly breaking up an uplink transmission of packet data on multiple transmissions of packet data on available access modes of the sending UE-2; and
sending packet data of the transmissions on available access modes of the sending UE-1.

2. The method of claim 1, wherein the method executes the step of receiving a registration request at the service application (SA) server for establishing a call session between the sending UE-1 and the SA prior to the step of initiating.

3. The method of claim 2, wherein the step of retrieving comprises a step of communicating from a sending UE-1 to the service application (SA) server for retrieving available access modes of the one or more receiving UE-2.

4. The method of claim 2, wherein the method further comprises the steps of:
receiving available access modes of the sending UE-1 at the SA;
storing available access modes for the sending UE-1; and
sending update of status of available access modes from the sending UE-1 to the SA.

5. The method of claim 2, wherein the method further comprises a step of randomly receiving packet data on available access modes of the one or more receiving UE-2.

6. The method of claim 1, wherein the method further comprises the steps of:
buffering packet data at the one or more receiving UE-2; and
reordering sent packet data at the SS middleware of the one or more receiving UE-2 in order to obtain the transmission of packet data originally sent from the UE-1 before the UE-1 randomly breaks up an uplink transmission of packet data on multiple transmissions.

7. The method of claim 1, wherein the UE-1 is the receiving UE and the UE-2 is the sending UE.

8. A user equipment (UE-1) for transmitting packet data in a packet data network, the UE-1 comprising:
a processing module for initiating communication with one or more receiving UE-2, operating a spread spectrum access (SS) middleware for retrieving available access modes of the one or more receiving UE-2; and
wherein the processing module retrieves available access modes for the one or more receiving UE-2, randomly breaks up an uplink transmission of packet data on multiple transmissions of packet data on available access modes of the UE-1 and sends packet data of the transmissions on available access modes of the UE-1.

9. The UE of claim 8, wherein the processing module sends a registration request to a service application (SA) server for establishing a call session between the UE-1 and the SA prior to initiating communication to the one or more receiving UE-2.

10. The UE-1 of claim 9, wherein the processing module operates the SS middleware for communicating to the SA in order to receive available access modes of the UE-1 at the SA, storing available access modes for the UE-1 and sending update of status of available access modes from the UE-1 to the SA.

11. The UE-1 of claim 8, wherein the processing module randomly receives packet data transmissions randomly receiving packet data on available access modes of the UE-1.

12. The UE-1 of claim 8, wherein the processing module operates the SS middleware for buffering packet data received from the one or more UE-2 and reordering received packet data at the SS middleware from the one or more UE-2 for obtaining to obtain the transmission of packet data originally sent before the UE-2 randomly breaks up an uplink transmission of packet data on multiple transmissions.
